(19) United States
(12) Patent Application Publication
(10) Pub. No.: US 2005/0052947 A1
(43) Pub. Date: Mar. 10, 2005

(54) Stir stick chuck

(76) Inventors: Richard V. Claussen II, Stow, OH (US); William M. Smith JR., Stow, OH (US)

Correspondence Address: HAHN LOESER & PARKS, LLP, One GOJO Plaza, Suite 300, AKRON, OH, 44311-1076, US

(21) Appl. No.: 10/841,971

(22) Filed: May 6, 2004

Related U.S. Application Data
(60) Provisional application No. 60/468,356, filed on May 6, 2003.

(51) Int. Cl. B01F 5/12

(52) U.S. Cl. 366/343; 366/129

(57) ABSTRACT

The invention is directed to a stirring device which is simple in its construction, cost-effective to produce, and easily used and maintained with little effort. The device in an embodiment is a one-piece body member having a drill chuck to be selectively coupled for use with a drill to cause rotation of the body member. The body member has a plurality of apertures to hold multiple stir sticks of conventional design or other stirring mechanisms. The stir sticks or the like may be oriented in differing configurations to facilitate the stirring action of the plurality of sticks when rotated in the fluid.

### RELATE BACK

This application claims the benefit of U.S. Provisional Application No. 60/468,356 filed May 6, 2003.

### TECHNICAL FIELD

The present invention relates to an apparatus for stirring fluids, such as paint, which is usable with a device for causing rotational or other motion thereof, such as a drill. More particularly, the invention is directed to an apparatus which comprises a body member configured to removably retain a plurality of paint stir sticks or the like, with the body member having a drill chuck for fitting onto a standard electric drill for example. Upon operation of the drill, the device, and the stir sticks are rotated or otherwise moved to cause stirring of a fluid into which the sticks are positioned.

### BACKGROUND OF THE ART

Before applying paint that has been sealed in a can, it is typically recommended that the canned paint be mixed. This recommendation is based on the fact that during storage, various components of the paint may settle, and in order to assure a homogeneous product, some form of mixing is required. Various devices for stirring paint are known in the prior art. A paint stirring stick, made of wood, metal, or plastic, is typically used to mix paint by hand, but requires significant effort to properly mix the paint. Electric paint shaker devices that are able to shake individual or multiple cans of paint are also widely known.

Other devices are known, such as shown in U.S. Pat. No. 5,984,518 to King et al. (“King '518”), dated Nov. 16, 1999. This patent describes a method of mixing viscous fluids. The method utilizes a mixing apparatus that is comprised of a cage located at the end of a shaft. The cage is comprised of a central circular disc with an outer edge, top, and bottom sides. A number of vanes, spaced near the outer edged of the plate, extend from each side of the plate. In use, a user positions the mixing cage of the device in a container of fluid. The user connects the second end of the shaft to the rotary drive means, such as a drill, and rotates the cage within the fluid. King states that the mixing apparatus is an inexpensive method for mixing viscous fluids in a quick and effective manner.

Another patent in this field is U.S. Pat. No. 4,472,063 to Eickelmann (“Eickelmann '063”), dated Nov. 16, 1999. This patent describes a rotary mixer implement that includes an upright shaft that is adapted to be chucked in a rotary drill motor or the like and to extend downwardly generally centrally into a liquid container. Upper and lower guide rings coaxial with the shaft and spaced apart lengthwise of the shaft are supported from the shaft by elongated radially extending upper and lower sets of struts, preferably formed as flat strips with a pitch angle to serve as impeller blades. Two or more helically extending impeller blades interconnecting the struts near their outer ends where they join the rings continue the pitch of the strut blades and themselves serve as impellers. The use of this device assures efficient mixing of the liquids.

Another device is shown in U.S. Pat. No. 6,419,385 to Walls (“Walls '385”), dated Jul. 16, 2002. This patent describes a hand paint mixer having a one-piece lid with integral spout, vent and release tab, a one-piece shaft with integral hand crank, and a one-piece impeller having elongated Z-shaped blades. The Z-shaped blades are connected to the lower end of the shaft and have a common bottom edge of width greater than the diameter of the opening in the paint can in which the mixer is designed to be used.

Although such devices can facilitate proper mixing of fluids such as paint, the devices are relatively complex to manufacture and use, and are also costly to produce. Such devices further are designed to be reused repeatedly, and therefore require manual cleaning and maintenance, making use more difficult.

### SUMMARY OF THE INVENTION

Based upon the foregoing, there is a need to provide a device which will facilitate stirring of a liquid medium, in a cost-effective configuration, which is easily used and maintained system. It is therefore an object of the invention to provide a stirring device which is simple in its construction, cost-effective to produce, and easily used and maintained with little effort. The device may comprise a one-piece body member having a drill chuck to be selectively coupled for use with a drill to cause rotation of the body member. The body member has a plurality of apertures to hold multiple stir sticks of conventional design or other stirring mechanisms. The stir sticks or the like may be oriented in differing configurations to facilitate the stirring action of the plurality of sticks when rotated in the fluid.

The device, an embodiment of which is shown and described in the following description and drawings, achieves these and other objects and advantages of the present invention.

### BRIEF DESCRIPTION OF THE DRAWINGS

The present invention will be better understood when reference is made to the accompanying drawings, wherein identical parts are identified with identical reference numerals, and wherein:

FIG. 1 is a perspective view of the preferred embodiment of the new and improved apparatus for supporting multiple paint stirring sticks and for coupling to an electric drill.

FIG. 2 is an enlarged perspective view of the device shown in FIG. 1 but illustrating it from the opposite side thereof.

FIG. 3 is a top elevational view of the device of FIG. 2.

### DETAILED DESCRIPTION OF A PREFERRED EMBODIMENT

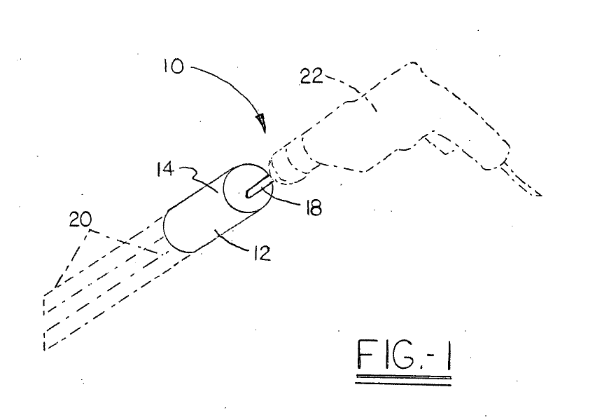

The invention will now be described with reference to FIGS. 1-3, which shows an embodiment of the apparatus, being generally designated 10. The apparatus 10 may comprise a body member 12, having a first portion 14 adapted to selectively retain a plurality of stirring sticks 20 or other stirring devices. The sticks 20 may be removably retained in one of the plurality of apertures 16 forms in body portion 14. As shown in this embodiment, the apertures 16 can be oriented at differing orientations relative to one another, to facilitate the mixing action therebetween. The body member 12 also has a second section 18, being configured for selective coupling to an electric drill 22 or other device to impart rotary or other motion to the sticks 20 with the device 10. The section 18 may simply be a post designed to be chucked with a drill 22, or other suitable structure for selective operational attachment to the drill 22 or other motion-imparting device. The body member 12 may be formed of a plastic material, allowing it to be easily molded or extruded for cost-effective manufacture. As an example, the body member portion 14 may be cylindrical, and portion 18 integrally formed as a drive shaft. The portion 14 may have a flat outer surfaces 15, with drive shaft 18 formed as an extension from one surface 15.

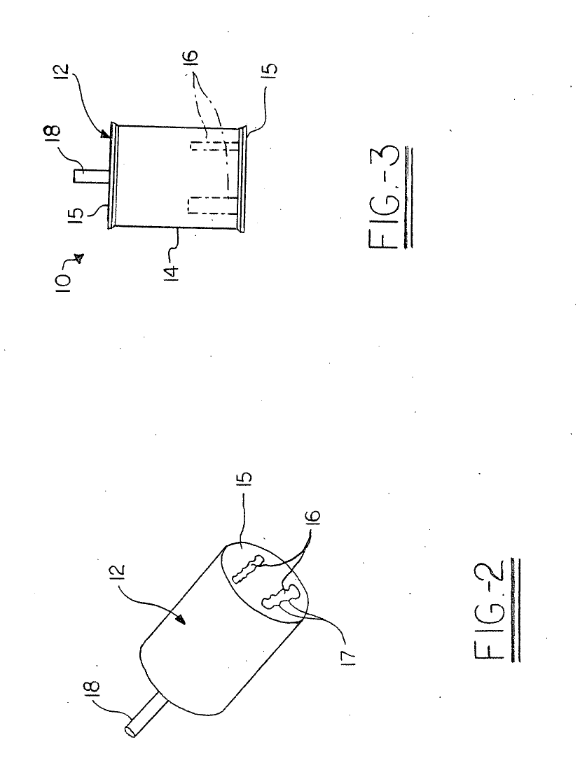

In this embodiment, the device 10 may also include structures to positively retain the plurality of stir sticks 20. As shown in FIG. 2, the apertures 16 may have retaining structures 17 which frictionally engage the stir sticks 20, and yet allow simple insertion and removal thereof. The retaining structure may be a plurality of ridges 17, serrations in the apertures or the like. As also seen in FIG. 2, the apertures 16 may be oriented or angled in such a way that when stirring sticks are inserted into the openings, the stirring sticks work in conjunction with one another to cause significant turbulence therebetween to facilitate stirring and mixing of a fluid, such as paint. In this embodiment, one of the sticks 20 may be angled approximately 5-20° from parallel relative to the other stick 20. In the embodiment shown, one of the sticks 20 is 13° offset from the other stick 20.

The drive shaft 18 may be formed to extend rearwardly from the rear end of the body portion 14. As an example, the drive shaft 18 may have a 0.375-inch diameter, to provide desired structural integrity for retention and use in association with an electric drill 22 or other motion-imparting device.

The present invention is a reusable holder for multiple paint stirring sticks commonly provided with cans of paint, stain, etc, used in conjunction with an electric drill. The present invention has advantages over mixing a can of paint by hand. First, the invention decreases the mixing time of the paint by utilizing the speed of a power tool. It also reduces the time for clean up since the stirring sticks used with the holder are simply removed from the holder after use and disposed of in a suitable container. The present invention also has the advantage of not requiring the use of any chemicals or water that are typically necessary of cleaning conventional paint mixing equipment. The present invention is lightweight, has no moving parts, and is formed of a rigid material, preferably plastic. In addition, the body 12, and particularly portion 14 provides a surface that allows graphical information to be positioned thereon, such as for the placement of advertising or commercial information.

Although the invention has been shown and described with respect to a particular embodiment, it will be understood by those skilled in the art that various changes or modifications in form and detail may be made without departing from the spirit and scope of the invention as defined in the appended claims.

1. A device for stirring of fluids, comprising a body member having a first and second ends, the first end including a mounting member adapted for mounting in association with a rotation device, and the second end including at least one stirring member extending outward from the second end which can be introduced into a fluid to be stirred, wherein upon rotation of the body member by a rotation device, the stirring member is rotated to stir the fluid into which it is introduced.

2. The device according to claim 1, wherein the body member is a molded of a polymeric material.

3. The device according to claim 1, wherein the body member is formed of an extruded polymeric material.

4. The device according to claim 1, wherein the body member has a generally cylindrical configuration.

5. The device according to claim 1, wherein the at least one stirring member is selectively separable from the body member.

6. The device according to claim 5, wherein the at least one stirring member is selectively secured into at least one slot formed in association with the second side of the body member.

7. The device according to claim 6, wherein the at least slot includes at least one retaining mechanism to positively retain the stirring member therein.

8. The device according to claim 7, wherein the at least one retaining mechanism is a ridge formed in the slot which frictionally engages the at least one stirring member.

9. The device according to claim 1, wherein a plurality of stirring members extend outwardly of the second side of the body member.

10. The device according to claim 9, wherein the plurality of stirring members are selectively separable from the body member.

11. The device according to claim 1, wherein the at least one stirring member is a standard paint stir stick.

13. The device according to claim 12, wherein the plurality of stirring members are oriented to be angled between 5 to 20 degrees from parallel with respect to another.

14. The device according to claim 1, wherein the mounting member is a post adapted to be chucked with a hand-held power drill to impart rotational motion to the body member upon operation of the drill.

15. The device according to claim 1, wherein the body member has at least one side surface dimensioned to allow graphical material to be provided thereon which is visible during use.

16. A paint stirring device for mixing of paint in a container, comprising a body member having first and second ends and at least one side surface, the first end including a mounting member extending outwardly therefrom and being adapted for mounting in association with a rotation imparting device, and the second end including a plurality of stirring members extending outwardly therefrom, the body member being selectively mounted in association with the rotation imparting device and the plurality of stirring members being selectively inserted into a container of paint, such that upon rotation of the body member, the stirring members cause agitation and turbulence of paint within the container to effectively mix the paint therein.

17. The device according to claim 16, wherein the plurality of stirring members are selectively separable from the body member.

18. The device according to claim 17, wherein the plurality of stirring members are selectively secured into a plurality of slots formed in association with the second side of the body member.

19. The device according to claim 18, wherein the plurality of slots include at least one retaining mechanism to positively retain a stirring member therein.

20. The device according to claim 16, wherein the plurality of stirring members are oriented non-parallel to one another.
